(19) United States
(12) Patent Application Publication
(10) Pub. No.: US 2024/0340778 A1
(43) Pub. Date: Oct. 10, 2024

(54) METHOD AND APPARATUS FOR INDICATING LOSS OF COVERAGE IN NETWORK

(71) Applicant: Samsung Electronics Co., Ltd., Suwon-si (KR)

(72) Inventor: Mahmoud WATFA, Staines (GB)

(21) Appl. No.: 18/630,440

(22) Filed: Apr. 9, 2024

(30) Foreign Application Priority Data
Apr. 10, 2023 (GB) 2305251.7
Jul. 25, 2023 (GB) 2311429.1
Mar. 7, 2024 (GB) 2403336.7

(51) Int. Cl. H04W 48/16; H04W 60/04; H04W 64/00

(52) U.S. Cl. CPC H04W 48/16; H04W 60/04; H04W 64/006

(57) ABSTRACT

The disclosure relates to a 5G or 6G communication system for supporting a higher data transmission rate. A method performed by a user equipment (UE) in a network is provided. The method includes transmitting, to the network, a first message, in response to the first message, receiving, from the network, a second message, and in response to the receiving of the second message, starting a timer in case that a condition is satisfied, wherein the condition is satisfied in case that the first message includes information indicating a duration of an unavailability period, but does not include information indicating a start of the unavailability period, and wherein the unavailability period is a period of time during which the UE is unable to access the network.

### CROSS-REFERENCE TO RELATED APPLICATION(S)

This application is based on and claims priority under 35 U.S.C. § 119 (a) of a United Kingdom patent application number 2305251.7, filed on Apr. 10, 2023, in the United Kingdom Intellectual Property Office, and of a United Kingdom patent application number 2311429.1, filed on Jul. 25, 2023, in the United Kingdom Intellectual Property Office, and of a United Kingdom patent application number 2403336.7, filed on Mar. 7, 2024, in the United Kingdom Intellectual Property Office, the disclosure of each of which is incorporated by reference herein in its entirety.

### BACKGROUND

### 1. Field

The disclosure relates to loss of coverage in a network. More particularly, the disclosure relates to one or more techniques for indicating an expected loss of coverage, controlling release of a Non Access Stratum (NAS) signalling connection, and/or controlling re-gaining of coverage after being out of coverage in a 3^{rd} Generation Partnership Project (3GPP) 5^{th} Generation (5G) New Radio (NR) Non Terrestrial Network (NTN).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

Herein, the following documents are referenced and the contents thereof are incorporated into the disclosure:
[1] 3GPP TS 23.501 V18.1.0
[2] 3GPP TS 24.501 V18.2.1

Various acronyms, abbreviations and definitions used in the disclosure are defined at the end of this description.

### Overview of Satellite Access for 5GC

One of the areas currently under development in 3GPP 5G wireless technology is support for NTNs. An NTN is a network in which one or more nodes (e.g. a Next Generation (NG) Radio Access Network (RAN) node) are provided by a non-terrestrial infrastructure, for example a satellite or High Altitude Platform Station (HAPS). Advantages of using an NTN include (i) extending coverage to regions, such as remote areas, with limited or no coverage from more traditional terrestrial networks, (ii) providing continuous coverage in the event of inoperability of traditional terrestrial networks, such as during natural disasters, and (iii) enhancing overall reliability, resilience and capacity when used in conjunction with existing terrestrial networks.

A satellite network implementing a network node provides coverage through one or more radio beams forming a “footprint” on the surface of the Earth defining a coverage area or cell. An NTN cell may be Earth-moving (i.e. moving over the Earth's surface according to the motion of the satellite, for example in the case of a Lower Earth Orbit (LEO) satellite), Earth-fixed (i.e. a fixed area of the Earth's surface, for example in the case of a Geosynchronous Equatorial Orbit (GEO) satellite) or quasi-Earth-fixed (i.e. a fixed area of the Earth's surface but is maintained for only a limited time as the satellite passes by).

3GPP is developing solutions for the use of satellite access for connecting IoT devices to the core network such as EPC or 5GC.

One of the related aspects of this feature is discontinuous coverage (DC) which is that a satellite's coverage is not always available for the User Equipment (UE), and hence it is discontinuous—see section 5.4.13 of [1]. The UE may be aware of its out-of-coverage period which indicates the timing information for when a UE is expected to be out of coverage and when the UE is expected to re-gain coverage again. The UE out-of-coverage period may consider current and expected future locations of the UE. The following are specified in [1]:
“If the UE is able to determine its own UE out-of-coverage period, and decides to remain in no service the following applies:
   the UE triggers the Mobility Registration Update procedure to inform the network of its UE out-of-coverage period
If the UE is not able to determine its own UE out-of-coverage period but can determine that it is about to lose coverage, the following applies:
   The UE triggers the Mobility Registration Update procedure and indicates that the UE is about to lose coverage due to discontinuous coverage but does not provide a UE out-of-coverage period.
   In this case, if the AMF is able to determine a UE out-of-coverage period based on satellite coverage availability information, as described below, the AMF provides an expected unavailability duration to the UE in the Registration Accept. The AMF may take the out of coverage period into account when determining Periodic Registration Update timer value for the UE. The AMF stores the information that the UE is unavailable in UE context, and considers the UE is unreachable (i.e. clear the PPF in AMF) until the UE enters CM-CONNECTED state.”

From the above, it can be seen that the UE can either indicate it's actual out-of-coverage period, or it can indicate that it is about to lose coverage when it does not know the precise out-of-coverage period.

[2] defines an Unavailability period duration IE which can be used by a UE to indicate its unavailability period. This IE can be sent in the Registration Request message. Furthermore this IE is a GRPS timer 3 as described in the message definition for the Registration Request message in section 8.2.6 of [2].

Additionally, the following is stated in section 5.4.13.5 in order to avoid congestion control for UEs that return from coverage loss:
“The AMF and UE may only use the procedure defined in this clause if both the UE and AMF indicate “Discontinuous Coverage Supported”, see clause 5.4.13.1.
In order to avoid a large number of UEs causing excessive signalling load on the network when re-gaining coverage after being out of coverage, the AMF may determine a maximum waiting time before UEs are allowed to initiate NAS signalling with the network, as described in this clause.
In this case, the AMF determines this maximum waiting time based on network configuration, priority users and priority service as specified in TS 23.122 and TS 24.501 [47]. The AMF sends this maximum waiting time to individual UEs during the Registration procedure or UE Configuration Update procedure.
If the UE receives a maximum waiting time from the network in a Registration Accept or UE Configuration Update Command message, the UE shall replace any previously received maximum waiting time on the same RAT type and PLMN with this one. Upon returning in coverage after being out of coverage due to discontinuous coverage, the UE sets the discontinuous coverage wait timer value to a random value up to and including the latest maximum waiting time for this PLMN and RAT type, and starts this timer. The UE shall not initiate any NAS signalling on that RAT Type and PLMN while the discontinuous coverage wait timer is running.
The UE shall stop the discontinuous coverage wait timer and initiate NAS signalling if the UE receives paging message, has pending emergency services or when UE enters a TAI outside the registration area.
Editor's note: It is for CT WG1 to decide whether the maximum wait time will require a new IE or reuse existing IE used for MINT i.e. disaster return wait range information. SA WG2 specifications will be aligned based on CT WG1 decision.”

As can be seen, the requirements on how to achieve this is left up to anther 3GPP group (namely CT WG1) to solve.

However, what is important to note is that the timer provided to a UE is not a range but rather it is a single timer representing the maximum timer that the UE can wait and hence the UE should select a random timer value that does not go beyond this maximum timer.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a one or more techniques for indicating an expected loss of coverage, controlling release of a Non Access Stratum (NAS) signalling connection, and/or controlling re-gaining of coverage after being out of coverage in a 3^{rd} Generation Partnership Project (3GPP) 5^{th} Generation (5G) New Radio (NR) Non Terrestrial Network (NTN).

Additional aspects will be set forth in part in the description which follows and, in part, will be apparent from the description, or may be learned by practice of the presented embodiments.

In accordance with an aspect of the disclosure, a method for performed by a user equipment (UE) in a network is provided. The method includes transmitting, to the network, a first message, in response to the first message, receiving, from the network, a second message, and in response to the receiving of the second message, starting a timer in case that a condition is satisfied, wherein the condition is satisfied in case that the first message includes information indicating a duration of an unavailability period, but does not include information indicating a start of the unavailability period, and wherein the unavailability period is a period of time during which the UE is unable to access the network.

In accordance with another aspect of the disclosure, a user equipment (UE) is provided. The UE includes a transceiver, memory storing one or more computer programs, and one or more processors communicatively coupled to the transceiver, and the memory, wherein the one or more computer programs include computer-executable instructions that, when executed by the one or more processors, cause the UE to transmit, to a network, a first message, in response to the first message, receive, from the network, a second message, and in response to receiving the second message, start a timer in case that a condition is satisfied, wherein the condition is satisfied in case that the first message includes information indicating a duration of an unavailability period, but does not include information indicating a start of the unavailability period, and wherein the unavailability period is a period of time during which the UE is unable to access the network.

In accordance with another aspect of the disclosure, one or more non-transitory computer-readable storage media storing one or more computer programs including computer-executable instructions that, when executed by one or more processors of a user equipment (UE), cause the UE to perform operations are provided. The operations include transmitting, to the network, a first message, in response to the first message, receiving, from the network, a second message, and in response to the receiving of the second message, starting a timer in case that a condition is satisfied, wherein the condition is satisfied in case that the first message includes information indicating a duration of an unavailability period, but does not include information indicating a start of the unavailability period, and wherein the unavailability period is a period of time during which the UE is unable to access the network.

Accordingly, embodiments provide a method performed by a terminal in a wireless communication system, the method comprising: transmitting, to an access and mobility management function (AMF), a message; identifying whether the terminal has included information on an unavailability and has not included information on a start of an unavailability period in the message; and in case that the terminal has included the information on the unavailability and has not included the information on the start of the unavailability period in the message, starting a timer associated with releasing a non-access stratum (NAS) signalling connection,

wherein the information on the unavailability comprises at least one of information indicating a reason for the unavailability, information indicating a presence of information on an unavailability period duration, or information indicating a presence of the information on the start of the unavailability period. In accordance with another aspect of the disclosure, wherein the message comprises a tracking area update request message or a registration request message.

In accordance with another aspect of the disclosure, wherein the information on the unavailability providing the unavailability type further comprises at least one of information on a length of unavailability information contents, or the information on the unavailability type.

In accordance with another aspect of the disclosure, wherein, in case that the information indicating the presence of the information on the unavailability period duration indicates that the information on the unavailability period duration is present, the information on the unavailability further comprises the information on the unavailability period duration,

wherein, in case that the information indicating the presence of the information on the start of the unavailability period indicates that the information on the start of the unavailability period is present, the information on the unavailability further comprises the information on the start of the unavailability period.

Accordingly, embodiments provide a method performed by a method performed by an access and mobility management function (AMF) in a wireless communication system, the method comprising: receiving, from a terminal, a message; wherein, in case that the terminal has included information on an unavailability and has not included information on a start of an unavailability period in the message, a timer associated with releasing a non-access stratum (NAS) signalling connection is started, wherein the information on the unavailability comprises at least one of information indicating a reason for the unavailability, information indicating a presence of information on an unavailability period duration, or information indicating a presence of the information on the start of the unavailability period.

Accordingly, embodiments in a wireless communication system, the terminal comprising: a transceiver; and at least one processor coupled with the transceiver and configured to: transmit, to an access and mobility management function (AMF), a message, identify whether the terminal has included information on an unavailability and has not included information on a start of an unavailability period in the message, and in case that the terminal has included the information on the unavailability and has not included the information on the start of the unavailability period in the message, start a timer associated with releasing a non-access stratum (NAS) signalling connection, wherein the information on the unavailability comprises at least one of information indicating a reason for the unavailability, information indicating a presence of information on an unavailability period duration, or information indicating a presence of the information on the start of the unavailability period.

Accordingly, embodiments provide an access and mobility management function (AMF) in a wireless communication system, the AMF comprising:
a transceiver; and
at least one processor coupled with the transceiver and configured to:
receive, from a terminal, a message,
wherein, in case that the terminal has included information on an unavailability and has not included information on a start of an unavailability period in the message, a timer associated with releasing a non-access stratum (NAS) signalling connection is started, wherein the information on the unavailability comprises at least one of information indicating a reason for the unavailability, information indicating a presence of information on an unavailability period duration, or information indicating a presence of the information on the start of the unavailability period.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method, for a UE in a network, for indicating an expected loss of coverage with a network access node according to an embodiment of the disclosure;

FIG. 2 illustrates a method, for a UE in a network according to an embodiment of the disclosure;

FIG. 3 illustrates a method, for a UE in a network, for controlling release of a NAS signalling connection according to an embodiment of the disclosure;

FIG. 4 illustrates an Information Element (IE) according to an embodiment of the disclosure;

FIG. 5 illustrates a method, for a UE in a network, for controlling re-gaining of coverage after being out of coverage with a network access node according to an embodiment of the disclosure; and

FIG. 6 is a block diagram of a network entity that may be used in certain examples according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the disclosure.

The terms and words used herein are not limited to the bibliographical or standard meanings, but, are merely used to enable a clear and consistent understanding of the disclosure.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the disclosure provide one or more techniques relating to loss of coverage in a network. For example, certain examples of the disclosure provide one or more techniques for indicating an expected loss of coverage, controlling release of a NAS signalling connection, and/or controlling re-gaining of coverage after being out of coverage in a 3GPP 5G NR NTN. However, the skilled person will appreciate that the disclosure is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a base station or the like (e.g. Base Station (eNB), 5G Base Station (gNB), Base Station (NB), RAN node, access point, wireless point, transmission/reception point, central unit, distributed unit, radio unit, remote radio head, etc.) in the examples below may be applied to any other suitable type of entity performing RAN functions, and the functionality of a UE or the like (e.g. electronic device, user device, mobile station, subscriber station, customer premises equipment, terminal, remote terminal, wireless terminal, vehicle terminal, etc.) in the examples below may be applied to any other suitable type of device.

A particular network entity may be implemented as a network element on a dedicated hardware, as a software instance running on a dedicated hardware, and/or as a virtualized function instantiated on an appropriate platform, e.g. on a cloud infrastructure.

The skilled person will appreciate that the disclosure is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the disclosure may be provided in the form of an apparatus/device/network entity configured to perform one or more defined network functions and/or a method therefor. Certain examples of the disclosure may be provided in the form of a system (e.g. network or wireless communication system) comprising one or more such apparatuses/devices/network entities, and/or a method therefor.

In the techniques of the related art, for example those referred to above, the following problems occur:

1. There are no defined details by which a UE can indicate its loss of coverage without providing an actual out-of-coverage period.

The Unavailability period duration IE is used to indicate the actual period of the UE's unavailability. However, the UE may also indicate that it will lose coverage without knowing the actual unavailability period but how this indication should be performed is not clear, for example which information element to use to do so. As such it is not possible to currently send a coverage loss indication without knowing how the NAS protocol can actually convey this.

2. Unnecessary prolongation of the NAS connection when the UE does not know its precise out of coverage period.

The UE starts the timer T3540 as a means to ensure that the NAS connection will be released, locally by the UE, if the network does not release the NAS connection within the duration of the timer. Hence the expiry of the timer will lead to the UE's local NAS connection release. There are numerous conditions for starting the timer as described in section 5.3.1.3 of [2], where one of these conditions is as follows:
“8) the UE has included Unavailability period duration IE in the REGISTRATION REQUEST message;”.

The above does not cover the case when the UE does not know the actual unavailability period but indeed indicates to the network that it (i.e. the UE) is about to lose coverage as required in [1] (and which is quoted earlier). Therefore, when the UE indicates that it will lose coverage, if the network does not release the UE's NAS connection and the UE does not start T3540, then the UE will unnecessarily remain in connected mode until the network releases the connection or the coverage is lost. The UE will hence waste power by remaining in connected mode although it does not need to.

3. No solution to communicate a maximum wait timer to the UE.

As stated earlier, the network may provide a maximum wait timer to the UE which helps with congestion control as the UEs will set a wait timer value “to a random value up to and including the latest maximum waiting time”.

The specification in [2] uses a similar timer that is called registration wait range information element which is encoded as follows (see section 9.11.3.84 of [2]):
“Registration wait range
The purpose of the registration wait range information element is to provide the disaster roaming wait range or the disaster return wait range to the UE.
The registration wait range information element is coded as shown in FIG. 9.11.3.84.1 and table 9.11.3.84.1.
The registration wait range is a type 4 information element, with a length of 4 octets.

FIG. 9.11.3.84.1: Registration wait range information element

| | | | | | | | |
|---|---|---|---|---|---|---|---|
| 8 | 7 | 6 | 5 | 4 | 3 | 2 | 1 |

| | |
|---|---|
| Registration wait range IEI | octet 1 |
| Length of registration wait range | octet 2 |
| Minimum registration wait time | octet 3 |
| Maximum registration wait time | octet 4 |

Table 9.11.3.84.1: Registration wait range information element

Minimum registration wait time (octet 3)
The minimum registration wait time contains the minimum duration
of the registration wait time, encoded as octet 2 of the GPRS timer
information element (see 3GPP TS 24.008 [12] subclause 10.5.7.3).
Maximum registration wait time (octet 4)
The maximum registration wait time contains the maximum duration
of the registration wait time, encoded as octet 2 of the GPRS timer
information element (see 3GPP TS 24.008 [12] subclause 10.5.7.3).

As can be seen, the above IE cannot be used for a UE to wait after return from discontinuous coverage because the Registration wait range (as the name implies) provides a range which is defined by a minimum value and a maximum value. This does not match the requirement for discontinuous coverage which requires the network to provide a maximum wait timer only, i.e. no minimum value is required. As such there is no proposed method by which the above IE can be re-used for this purpose of discontinuous coverage.

Certain examples of the disclosure provide one or more solutions to address the above problems. The skilled person will appreciate that the solutions can be used in any order or combination, and that the solutions may be applied to any system, such as 4^{th} Generation (4G) (Evolved Packet System (EPS)), 5G System (5GS) or other systems that may emerge in the future such as (but not limited to) 6^{th} Generation (6G).

Certain examples of the disclosure provide a method, for a UE in a network, the method comprising sending a first message of certain type to the network; and in response to the receiving of a second message from the network in response to the first message, starting a timer if a condition is satisfied, wherein the condition comprises: the message (i) includes information indicating a duration of an unavailability period, and (ii) does not include information indicating a start of the unavailability period, and wherein the unavailability period is a period of time during which the UE is unable to access the network.

In certain examples, the first message may be a registration request message and the second message may be a registration accept message, or the first message may be a tracking area update request message and the second message may be a tracking area update accept message.

In certain examples, the timer may be a 3GPP 5G timer T3540 or 3GPP 4G timer T3440.

In certain examples, the method may further comprise: upon expiry of the timer, entering an idle mode.

In certain examples, the network may be a network with discontinuous coverage.

In certain examples, the network may comprise an NTN.

In certain examples, the first message may include an IE comprising one or more of the following: first information indicating a reason for the unavailability period; second information indicating whether or not the information indicating the duration of the unavailability period is present in the IE; third information comprising the information indicating the duration of the unavailability period, if present in the IE; fourth information indicating a length of the third information; fifth information indicating whether or not the information indicating the start of the unavailability period is present in the IE; and sixth information comprising the information indicating the start of the unavailability period, if present in the IE.

In certain examples, the first, second, third, fourth, fifth and/or sixth items of information may be carried in respective octets and/or bits of the IE.

In certain examples, the IE may be a 3GPP 5G Unavailability period duration IE.

In certain examples, the IE may be an IE dedicated to indicating discontinuous coverage.

In certain examples, the unavailability period may be a period of time during which network coverage for the UE is unavailable (e.g. due to discontinuous coverage) and/or for a reason local to the UE (e.g. a software update).

In certain examples, the UE may be in NI mode or S1 mode.

Certain examples of the disclosure (e.g. a first example) provide a method, for a UE in a network, for indicating an expected loss of coverage with a network access node, the method comprising: transmitting, to a core network entity (e.g. Access and Mobility Management Function (AMF) or Mobility Management Entity (MME)), a message (e.g. Registration Request message or Tracking Area Update Request message), wherein, if the UE can determine that a loss of coverage is expected to occur, the message includes an indication that the loss of coverage is expected to occur.

In certain examples (e.g. a second example according to the first example), if the UE cannot determine an out-of-coverage period, or if the UE can determine an out-of-coverage period but determines not to provide the out-of-coverage period, the message may not include an out-of-coverage period.

In certain examples (e.g. a third example according to the first or second examples), the indication may be included in a 5GS update type IE.

In certain examples (e.g. a fourth example according to the third example), the indication may comprise a predetermined field (e.g. predetermined bit) of the 5GS update type IE set to a predetermined value indicating that loss of coverage is expected to occur (e.g. and optionally to also indicate that an out-of-coverage period is not provided).

In certain examples (e.g. a fifth example according to the third or fourth examples), the message may not include an unavailability period duration IE.

In certain examples (e.g. a sixth example according to the first or second examples), the indication may be included in an unavailability period duration IE.

In certain examples (e.g. a seventh example according to the sixth example), the indication may comprise setting a timer field of the unavailability period duration IE to a predetermined value (e.g. to indicate that an out-of-coverage period is not provided).

In certain examples (e.g. an eighth example according to the sixth example), the indication may comprise setting a type of indication field to a first predetermined value indicating that the loss of coverage is expected to occur and that an out-of-coverage period is not indicated, and a timer field may not be included in the IE.

In certain examples (e.g. a ninth example according to the sixth example), the indication may comprise setting a type of indication field to a second predetermined value indicating that the loss of coverage is expected to occur, and a timer field comprising a value indicating an out-of-coverage period may be included in the IE.

In certain examples (e.g. a tenth example according to the first or second examples), the indication may be included in an IE other than a 5GS update type IE and an unavailability period duration IE (e.g. an IE dedicated to indicating that the loss of coverage is expected to occur and whether or not an out-of-coverage period is provided).

In certain examples (e.g. an eleventh example according to any of the first to fourth and tenth examples), if the UE can determine an out-of-coverage period, the message may further include an out-of-coverage period.

Certain examples of the disclosure (e.g. a twelfth example) provide a method, for a UE in a network, for controlling release of a NAS signalling connection, the method comprising: transmitting, to a core network entity (e.g. AMF), a first message (e.g. Registration Request message or Tracking Area Update Request message); and starting a timer (e.g. T3540 or T3440) if a certain condition is satisfied, wherein the NAS signalling connection is released upon expiry of the timer, and wherein the condition comprises: the UE has indicated (e.g. in the first message) that a loss of coverage with a network access node is expected to occur.

In certain examples (e.g. a thirteenth example according to the twelfth example), the timer may be started in response to receiving a second message (e.g. Registration Accept message) in response to the first message.

In certain examples (e.g. a fourteenth example according to the twelfth or thirteenth examples), the condition may further comprise: the UE has not indicated an out-of-coverage period (e.g. the first message does not include an out-of-coverage period).

In certain examples (e.g. a fifteenth example according to the twelfth, thirteenth or fourteenth examples), the condition may further comprise: the first message does not include an unavailability period duration IE.

In certain examples (e.g. a sixteenth example according to any of the twelfth to fifteenth examples), the condition may further comprise: the UE has not indicated (e.g. the first message does not include) a start of an unavailability period.

Certain examples of the disclosure (e.g. a seventeenth example) provide a method, for a UE in a network, for controlling re-gaining of coverage after being out of coverage with a network access node, the method comprising receiving, from a core network entity (e.g. AMF), a message (e.g. Registration Accept message or UE Configuration Update Command message), wherein the message includes an indication of a maximum waiting time before the UE is allowed to initiate NAS signalling with the network when re-gaining coverage after being out of coverage.

In certain examples (e.g. an eighteenth example according to the seventeenth example), the message may not include an indication of a minimum waiting time before the UE is allowed to initiate NAS signalling with the network.

In certain examples (e.g. a nineteenth example according to the seventeenth example), the message may include a field for indicating a minimum waiting time, and a value of the field may be set (e.g. to zero or other predetermined value) to indicate that there is no (or deactivated) minimum waiting time.

In certain examples (e.g. a twentieth example according to the seventeenth, eighteenth or nineteenth examples), the indication may be provided in an IE (e.g. a registration wait range IE or a maximum signalling wait timer IE).

In certain examples (e.g. a twenty first example according to any of the first to twentieth examples), the loss of coverage may be due to discontinuous reception.

In certain examples (e.g. a twenty second example according to any of the first to twenty first examples), the access node may be a satellite.

Certain examples of the disclosure provide a UE configured to perform a method according to any example, aspect, embodiment and/or claim disclosed herein.

Certain examples of the disclosure provide a network entity (e.g. AMF) configured to cooperate with a UE in a network to perform a method according to any example, aspect, embodiment and/or claim disclosed herein.

Certain examples of the disclosure provide a network (or wireless communication system) comprising a UE according to any example, aspect, embodiment and/or claim disclosed herein.

Certain examples of the disclosure provide a computer program comprising instructions which, when the program is executed by a computer or processor, cause the computer or processor to carry out a method according to any example, aspect, embodiment and/or claim disclosed herein.

Certain examples of the disclosure provide a computer or processor-readable data carrier having stored thereon a computer program according to any example, aspect, embodiment and/or claim disclosed herein.

Various specific examples will now be described in more detail. The skilled person will appreciate that various techniques described in the disclosure in relation to “loss of coverage” and similar may also be applied to situations in which the UE is unable to access the network for other reasons, for example a reason local to the UE (e.g. a software update).

1. New protocol options to inform the network of loss of coverage.

Certain examples of the disclosure provide one or more techniques for indicating coverage loss to the network when the UE is not able to send its unavailability period.

### Option 1: New Bit in the 5GS Update Type IE

A new bit can be defined in the 5GS update type IE to indicate to the network that the UE is about to lose coverage. In certain examples, the coverage loss may be due to discontinuous coverage. In certain examples, the UE is not able to indicate its actual unavailability period. The current format of this IE from section 9.11.3.9A of [2] is as shown below:

| | | | | | | | |
|---|---|---|---|---|---|---|---|
| 8 | 7 | 6 | 5 | 4 | 3 | 2 | 1 |

| 5GS update type IEI | | | | | | octet 1 |
|---|---|---|---|---|---|---|
| Length of 5GS update type | | | | | | octet 2 |
| 0 | 0 | EPS- | 5GS- | NG-RAN- | SMS | octet 3 |
| Spare | Spare | PNB- | PNB- | RCU | requested | |

| | |
|---|---|
| CIoT | CIoT |

In certain examples, one or more of the spare bits that are available in this IE are used to provide the coverage loss indication to the network.

For example, a new bit, which may be called Coverage Loss Indication (CLI) bit (e.g. where this may be bit position 7 or any other bit position in the IE), can be defined. For example, this bit may provide the following indications:

A value of 0 may be used to indicate “No Coverage loss”.

A value of 1 may be used to indicate “Coverage loss, optionally due to discontinuous coverage”.

The skilled person will appreciate that this is just an example of how the bit can be used, and that any other suitable encoding of information may be used. The skilled person will also appreciate that the name CLI bit is merely an example and that any other suitable name may be used.

In certain examples, an IE may have the following format, where in this example the 7^{th} bit position is used as the bit for the indication described above.

| | | | | | | | |
|---|---|---|---|---|---|---|---|
| 8 | 7 | 6 | 5 | 4 | 3 | 2 | 1 |

| 5GS update type IEI | | | | | | octet 1 |
|---|---|---|---|---|---|---|
| Length of 5GS update type | | | | | | octet 2 |
| 0 | CLI | EPS- | 5GS- | NG- | SMS | octet 3 |
| Spare | | PNB- | PNB- | RAN- | requested | |

| | | |
|---|---|---|
| CIoT | CIoT | RCU |

In certain examples, the use of a bit to indicate ‘coverage loss (optionally due to discontinuous coverage) without providing the unavailability period’ may be mutually exclusive with the use of the Unavailability period duration IE. As such, if the relevant bit (e.g. CLI bit) is used to indicate ‘coverage loss (without knowing unavailability period)’, then the same NAS message should not include the Unavailability period duration IE. Therefore, when the UE sends a NAS message (e.g. Registration Request message or Tracking Area Update Request message) and sets the relevant bit (e.g. CLI bit) to indicate coverage loss where the UE does not know its unavailability period, then the Unavailability period duration IE should not be sent in the message.

If both the relevant bit is used (or set, e.g. such that it indicates coverage loss without knowing actual unavailability period) and the IE is sent, then the AMF may perform any suitable operation, for example one or more of the following:

Reject the NAS message, for example send Registration Reject or send a 5GMM STATUS message, and the AMF may send a new or existing 5GMM cause value.

Ignore the bit but process the Unavailability period duration IE.

Ignore the Unavailability period duration IE and process the bit. The AMF may optionally do so if the IE contains a timer value which indicates “deactivated” or zero.

In the case of an MME in EPS, the core network node would be an MME and the cause value would be an EMM cause value, and the MME may send the EMM STATUS message which would be the corresponding message (in S1 mode) to the 5GMM STATUS message (in N1 mode). As such, various techniques would also apply for the case of EPS or S1 mode.

Similarly, if the UE includes the Unavailability period duration IE (or optionally at least sets the timer to a value which is not ‘deactivated’ or not zero), then the UE should set the relevant bit (e.g. CLI bit) to a value which does not indicate coverage loss, for example the value 0 or any other suitable value.

The skilled person will appreciate that other existing IEs can also be used for the same purpose. Also, any of the spare bit positions can be used as described above. For example, the Additional information requested information element can be used but others (although not listed herein) can also be used. The skilled person will appreciate that the various techniques disclosed herein can also apply in EPS (or S1 mode accordingly).

### Option 2: Re-Use Unavailability Period Duration IE and Set Value to Zero or Deactivated

In this option, in order to indicate coverage loss (e.g. due to discontinuous coverage) when the UE does not know the actual unavailability period, the UE can do so by re-using the existing Unavailability period duration IE. For example, the UE may set the value of the timer to indicate ‘deactivated’ or to indicate a value of zero (or any other suitable value). As such, when the network (e.g. AMF or MME) receives this IE (or any equivalent IE) such that the value is set to zero or ‘deactivated’, then the network determines that the UE is indicating a coverage loss (e.g. due to discontinuous coverage) but the UE is not providing its unavailability period.

### Option 3: Redefine the Unavailability Period Duration IE

In this option, the Unavailability period duration IE is re-used but its contents are redefined. For example this may be done as follows (where this definition is referred to as alternative A):

| | | | | | | | |
|---|---|---|---|---|---|---|---|
| 8 | 7 | 6 | 5 | 4 | 3 | 2 | 1 |

| Unavailability period duration IEI | | octet 1 |
|---|---|---|
| Type of indication | | octet 2 |
| Unit | Timer value | octet 3 |

The first field (i.e. octet 1) indicates the type of the IEI to be the Unavailability period duration.

The second field (i.e. octet 2) indicates the type of the indication. For example, one or more of the following values may be defined:

Indication of loss of coverage (e.g. due to discontinuous coverage) without providing an actual unavailability period. For example, this may be used when the UE cannot determine its unavailability period. When this value is used, then the subsequent octet (i.e. octet 2 in the IE definition above) is not included (e.g. by the UE) in the IE.

Providing the unavailability period, or indication of unavailability period, i.e. the UE is providing the unavailability period. In this case the UE is indicating that it is going to be unavailable and it is also providing the unavailability period. When this value is used, then the subsequent octet (i.e. octet 2 in the IE definition above) is included (e.g. by the UE) in the IE. The subsequent octet (i.e. octet 2 in the IE definition shown above) will therefore provide the GPRS timer 3 value as defined in section 10.5.7.4a of TS 24.008.

In certain examples, the ‘Type of indication field’ may be an 8 bit field where parts of it may be reserved or the entire 8 bits can be used such that a particular set of bit values can represent the values or indications listed above.

Alternatively, although not disclosed above, in certain examples the second octet may be defined as 8 independent bit positions, and each bit position may be used to define a certain value or indication. For example, a first bit may be used as follows:

The value 0 can mean that the UE cannot determine its precise unavailability period but is indicating that it will lose coverage (optionally due to discontinuous coverage). When this is used, the subsequent field (i.e. octet 3) is not needed.

The value 1 can mean that the UE is providing the unavailability period and so the subsequent field is present and is set by the UE to indicate the unavailability period.

Alternatively, an independent/individual bit indication may be defined and dedicated for:

Coverage loss indication without unavailability period (and hence subsequent octet is not provided).

Indication of unavailability period (and hence subsequent octet is also provided).

In certain examples (referred to as alternative B), a length field may also be used as follows:

| | | | | | | | |
|---|---|---|---|---|---|---|---|
| 8 | 7 | 6 | 5 | 4 | 3 | 2 | 1 |

| Unavailability period duration IEI | | octet 1 |
|---|---|---|
| Length of the Unavailability period duration content | | octet 2 |
| Type of indication | | octet 3 |
| Unit | Timer value | octet 4 |

In this case, the length field (shown in octet 2) would simply inform the receiver (e.g. the AMF or MME) how many octets follow it. The rest of the octets may be as described above with the following modifications: octet 3 in alternative B may be the same as octet 2 in alternative A, and octet 4 in alternative B may be octet 3 in alternative A.

The skilled person will appreciate that other forms of this IE can also be used. For example, the length field may come after the Type of indication field in certain example. Then the techniques described above may be applied in terms of what these fields would mean (with a possible modification of the number of fields that might be expected to come after any given field, which would then be easy to anticipate) and how they can be used, etc.

### Option 4: a New IE is Used to Indicate Loss of Coverage (e.g. Due to Discontinuous Period) Optionally Without Providing the Actual Unavailability Period

In this option, a new indication, for example Discontinuous coverage indication IE, can be defined and used to indicate that the UE will lose coverage (e.g. due to discontinuous coverage). For example, the IE may be a Type Length Value (TLV) type 3 or type 4 IE. The following is an example of how to define such an IE:

| 8 | 7 | 6 | 5 | 4 | 3 | 2 | 1 | |
|---|---|---|---|---|---|---|---|---|
| Discontinuous coverage indication IEI | | | | | | | | octet 1 |
| Length of Discontinuous coverage indication contents | | | | | | | | octet 2 |
| 0 | 0 | 0 | 0 | 0 | 0 | 0 | 0 | octet 3 |

| | |
|---|---|
| Spare | CLI |

A bit position, for example referred to as CLI, can be used. The previous description of the CLI bit can apply here. Similarly, in certain examples the UE should not include this IE and the Unavailability period duration IE at the same time in the NAS message. As such, the inclusion of one or the other should be mutually exclusive. The same techniques descried above may be applied. Similarly, in certain examples if the AMF (or MME) receives both IEs, and at least the CLI bit is set to indicate that the coverage will be lost, then the AMF (or MME) may choose either to process the Discontinuous coverage indication IE or the Unavailability period duration IE or may reject the message or may send a 5GMM STATUS message (or EMM STATUS message). The same techniques described above may be applied.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

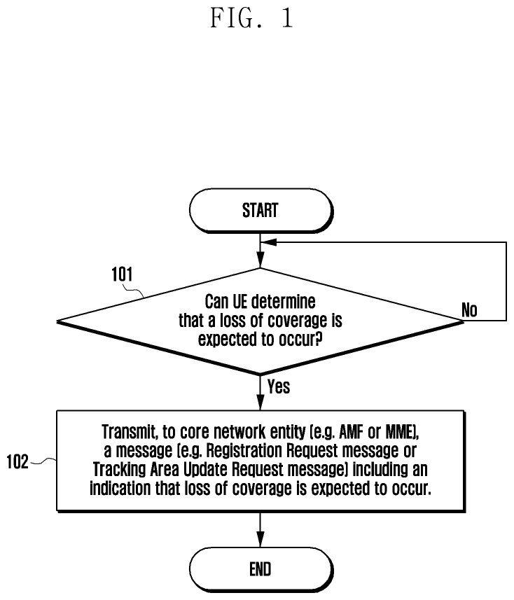

FIG. 1 illustrates a method, for a UE in a network, for indicating an expected loss of coverage with a network access node according to an embodiment of the disclosure.

In a first operation 101 it is determined whether the UE can determine that a loss of coverage is expected to occur.

In a second operation 102, if the UE can determine that a loss of coverage is expected to occur, the UE transmits, to a core network entity (e.g. AMF or MME), a message (e.g. Registration Request message or Tracking Area Update Request message) including an indication that loss of coverage is expected to occur.

The skilled person will appreciate that any other suitable IE type(s) may be defined and used for Discontinuous coverage indication.

The skilled person will appreciate that in the examples disclosed herein the various names of the IEs and/or bit positions, and the values they represent, or the indications they represent, are merely non-limiting examples. The skilled person will appreciate that any other suitable name of an IE, or a bit or a set of bits, may be used for the purposes described herein.

The skilled person will also appreciate that the various techniques disclosed herein may also be applied for EPS (i.e. when the UE is in S1 mode). The same or similar IEs can be defined.

Moreover, bit positions can be used as disclosed herein using existing IEs in S1 mode. For example, the spare bit, i.e. bit number 4, of the EPS attach type information element can be used as the CLI bit described above. Other IEs or bit positions can also be used in a same manner.

Accordingly, the techniques described herein may be used with a variety of possible IEs.

Moreover, the corresponding message can be used in EPS, although the NAS message names may not be the same. For example, the Tracking Area Update Request message in S1 mode can be the corresponding message of the Registration Request message in N1 mode. As such, the same techniques may be applied regardless of the message name, or IEs that are used to define new bit positions, etc. Similarly, the same UE behaviour can be applicable in N1 mode and in S1 mode and so the same network behaviour can also be applicable to the case of an AMF or MME.

The skilled person will appreciate that any of the proposals described above can also apply for the case when the UE is indicating (or sending indication of) loss of coverage (e.g. due to discontinuous coverage, or other reason), even if the UE is able to determine its unavailability period, or even if the UE is also providing this unavailability period. In certain examples, it is possible that both the loss of coverage indication and the actual unavailability period are sent by the UE, for example in the same message. The network can then process both information items and/or indications. Therefore, the techniques described above are not limited to only cases when the UE sends loss of coverage indication but without being able to determine (or provide) its unavailability period.

2. New condition to start T3540 (or T3440)

In certain examples, the UE should start T3540 in N1 mode after sending the Registration Request with an indication about coverage loss (e.g. due to discontinuous coverage) but optionally when the UE is not able to determine (and/or indicate) its unavailability period (or optionally when the UE does not include the Unavailability period duration IE) in the Registration Request message. For example, the UE may start the timer T3540 after it receives the Registration Accept message and if one or more of:
1) the UE receives a REGISTRATION ACCEPT message which does not include a Pending NSSAI IE or UE radio capability ID deletion indication IE;
2) the UE has set the Follow-on request indicator to “No follow-on request pending” in the REGISTRATION REQUEST message;
3) the UE has not included the Uplink data status IE in the REGISTRATION REQUEST message, or the UE has included the Uplink data status IE in the REGISTRATION REQUEST message but the REGISTRATION ACCEPT message indicates that no user-plane resources of any PDU sessions are to be re-established;
4) the UE has not included the Allowed PDU session status IE or has included the Allowed PDU session status IE indicating there is no PDU session(s) for which the UE allowed the user-plane resource to be re-established over 3GPP access in the REGISTRATION REQUEST message, or the UE has included the Allowed PDU session status IE in the REGISTRATION REQUEST message but the REGISTRATION ACCEPT message does not indicate that any user-plane resources of any PDU sessions are to be re-established;
5) the registration procedure has been initiated in 5GMM-IDLE mode, or the UE has set Request type to “NAS signalling connection release” in the UE request type IE in the REGISTRATION REQUEST message and the N1 NAS signalling connection release bit is set to “N1 NAS signalling connection release supported” in the 5GS network feature support IE of the REGISTRATION ACCEPT message;
6) the user-plane resources for PDU sessions have not been set up, except for the case the UE has set Request type to “NAS signalling connection release” in the UE request type IE in the REGISTRATION REQUEST message and the N1 NAS signalling connection release bit is set to “N1 NAS signalling connection release supported” in the 5GS network feature support IE of the REGISTRATION ACCEPT message;
7) the UE need not request resources for Vehicle to Everything (V2X) communication over PC5 reference point (see 3GPP TS 23.287 [6C]);
8) the UE has included Unavailability period duration IE in the REGISTRATION REQUEST message, or the UE has indicated that it will lose coverage (or that coverage loss will happen for the UE, optionally due to discontinuous coverage) and optionally the UE has not included any unavailability period (or has not included the Unavailability period duration IE) and optionally the UE did not include the Start of Unavailability Period; and
9) the UE need not request resources for 5G ProSe direct discovery over PC5 or 5G ProSe direct communication over PC5 (see 3GPP TS 23.304 [6E]).

The text shown above in underline is an example of the changes that can be made to the specifications to enable the technique described herein.

The techniques described above can similarly be made for EPS (or S1 mode) where the UE can start T3440 if it indicates that it will lose coverage (e.g. due to discontinuous coverage) but optionally when the UE is not able to determine (and/or indicate) its unavailability period (or optionally when the UE does not include the Unavailability period duration IE) in the Tracking Area Update Request message. For example, the following set of conditions can be verified in order to start T3440:

To allow the network to release the NAS signalling connection, the UE:
a) shall start the timer T3440 if the UE receives any of the EMM cause values #11, #12, #13, #14 (not applicable to the service request procedure), #15, #25, #31, #35, 42 or #78;
b) shall start the timer T3440 if:
   the UE receives a TRACKING AREA UPDATE ACCEPT message which does not include a UE radio capability ID deletion indication IE;
   the UE has not set the “active” flag in the TRACKING AREA UPDATE REQUEST message;
   the UE has not set the “signalling active” flag in the TRACKING AREA UPDATE REQUEST message;
   the TRACKING AREA UPDATE REQUEST message included an indication that the UE will lose coverage (e.g. due to discontinuous coverage) where optionally the UE did not include its unavailability period;
   the tracking area updating or combined tracking area updating procedure has been initiated in EMM-IDLE mode, or the UE has set Request type to “NAS signalling connection release” in the UE request type IE in the TRACKING AREA UPDATE REQUEST message and the NAS signalling connection release bit is set to “NAS signalling connection release supported” in the EPS network feature support IE of the TRACKING AREA UPDATE ACCEPT message; and
   the user plane radio bearers have not been set up.

The text shown above in underline is an example of the changes that can be made to the specifications to enable the technique described herein.

The skilled person will appreciate that the order of the condition may be either before or after what is shown above and hence does not matter. It can be verified in any order and/or combination.

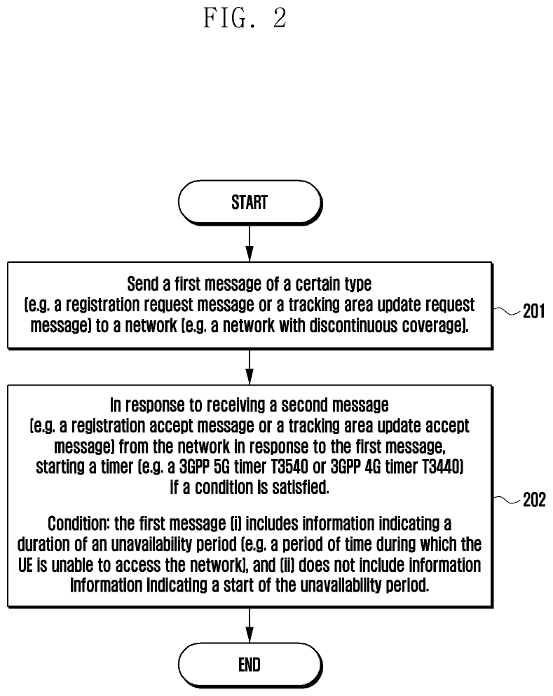

FIG. 2 illustrates a method, for a UE in a network according to an embodiment of the disclosure.

In a first operation 201, the UE sends a first message of a certain type (e.g. a registration request message or a tracking area update request message) to a network (e.g. a network with discontinuous coverage).

In a second operation 202, in response to the receiving of a second message (e.g. a registration accept message or a tracking area update accept message) from the network in response to the first message, the UE starts a timer (e.g. a 3GPP 5G timer T3540 or 3GPP 4G timer T3440) if a condition is satisfied. The condition comprises: the first message (i) includes information indicating a duration of an unavailability period (e.g. a period of time during which the UE is unable to access the network), and (ii) does not include information indicating a start of the unavailability period. For example, the unavailability period may be a period of time during which network coverage for the UE is unavailable (e.g. due to discontinuous coverage) and/or for a reason local to the UE (e.g. a software update).

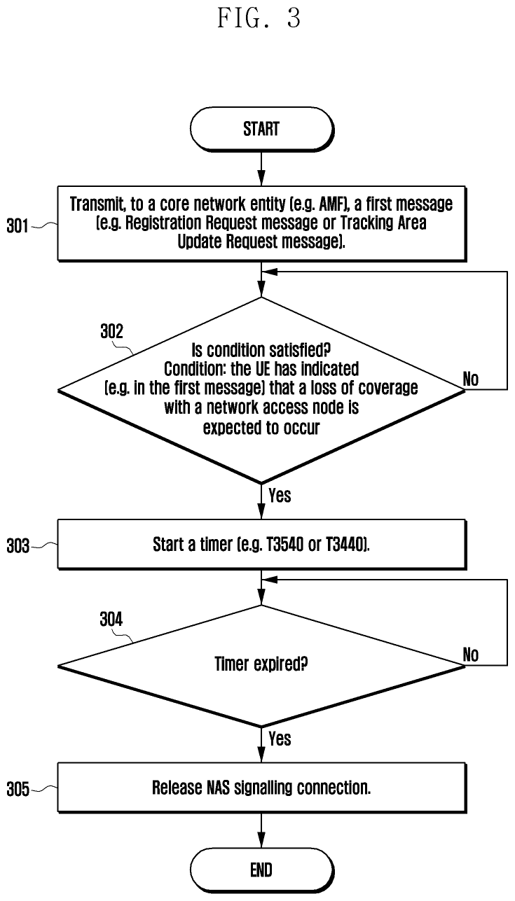

FIG. 3 illustrates a method, for a UE in a network, for controlling release of a NAS signalling connection according to an embodiment of the disclosure.

In a first operation 301, the UE transmits, to a core network entity (e.g. AMF), a first message (e.g. a Registration Request message or a Tracking Area Update Request message).

In a second operation 302, the UE determines whether a condition is satisfied. The condition comprises: the UE has indicated (e.g. in the first message) that a loss of coverage with a network access node is expected to occur.

In a third operation 303, if the condition is satisfied, the UE starts a timer (e.g. T3540 or T3440).

In a fourth operation 304, the UE determines if the timer has expired.

In a fifth operation 305, if the time has expired then the UE releases a NAS signalling connection.

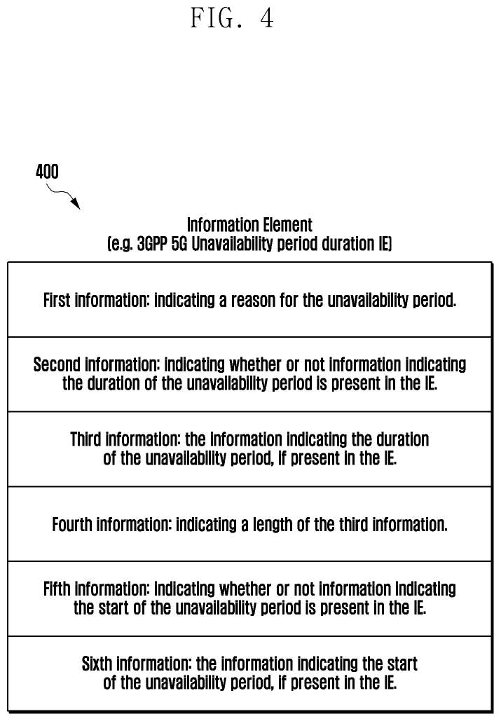

FIG. 4 illustrates an Information Element (IE) 400 that may be included in the first message according to an embodiment of the disclosure.

The IE (e.g. a 3GPP 5G Unavailability period duration IE) may comprise one or more of the following: first information indicating a reason for the unavailability period; second information indicating whether or not the information indicating the duration of the unavailability period is present in the IE; third information comprising the information indicating the duration of the unavailability period, if present in the IE; fourth information indicating a length of the third information; fifth information indicating whether or not the information indicating the start of the unavailability period is present in the IE; and sixth information comprising the information indicating the start of the unavailability period, if present in the IE. The skilled person will appreciate that the size, format, encoding and/or order of the information items may be modified.

3. New solution to send a maximum wait time to the UE.

In order to send a maximum wait time to the UE, one or more of the following techniques may be used.

Option 1: a new IE can be used for this purpose

A new IE may be defined. For example, this IE may be called a Maximum signalling wait timer, which indicates the maximum timer value that the UE should wait for before attempting any signalling with the network.

In certain examples, the encoding of this IE may be as follows:

| | | | | | | | |
|---|---|---|---|---|---|---|---|
| 8 | 7 | 6 | 5 | 4 | 3 | 2 | 1 |

| | |
|---|---|
| Maximum signalling wait timer IEI | octet 1 |
| Maximum wait time | octet 2 |

In this option, octet 2 is considered to be the value part of a GPRS timer which is in turn has the following encoding:

| | | | | | | | |
|---|---|---|---|---|---|---|---|
| 8 | 7 | 6 | 5 | 4 | 3 | 2 | 1 |

| GPRS Timer IEI | | octet 1 |
|---|---|---|
| Unit | Timer value | octet 2 |

As such, octet 2 of the Maximum signalling wait timer IE would be the same as octet 2 of the GPRS Timer IE.

The skilled person will appreciate that the IE described above may be a GPRS timer 2 or GPRS timer 3, and as such will have a total of 3 octets, where the first octet is the IEI as shown above, but octet 2 and octet 3 will be the same as octet 2 and octet 3, respectively, of a GPRS timer 2 or GPRS timer 3 (depending on the choice made, where these timers are defined in sections 10.5.7.4 and 10.5.7.4a of TS 24.008).

Option 2: re-use encoding of the Registration wait range but the network sets the minimum registration wait time field to zero or ‘deactivated’

In this option, a new Maximum signalling wait timer IE may be defined but its type is the same as the Registration wait range IE. The encoding can then look as follows:

| | | | | | | | |
|---|---|---|---|---|---|---|---|
| 8 | 7 | 6 | 5 | 4 | 3 | 2 | 1 |

| | |
|---|---|
| Maximum signalling wait timer IEI | octet 1 |
| Length of registration wait range | octet 2 |
| Minimum registration wait time | octet 3 |
| Maximum registration wait time | octet 4 |

As such, octets 2 to 4 of the IE described above are the same as octets 2 to 4 of the Registration wait range IE.

However, when the network provides this information element to a UE which is using satellite access and the network wants to provide a maximum waiting time as required in [1] (e.g. in order to mitigate congestion control), then the network should set octet 3 (i.e. the ‘Minimum registration wait time’ field) to zero (or to any suitable value which indicates ‘deactivated’).

A UE which receives an IE as described above with the ‘Minimum registration wait time’ field may behave as follows, where optionally this is a UE which supports discontinuous coverage and/or it has received this IE over a (3GPP) satellite access type:

The UE considers the minimum registration wait time field to always be zero (or deactivated). For example, if the value indicates deactivated then the UE may ignore this field or consider the minimum wait time to be zero.

The UE ignores the minimum registration wait time field and as such only considers the maximum registration wait time.

The UE, based on any combination of the above, considers that the wait time is up to a maximum of the timer value represented by the ‘Maximum registration wait time’ field and optionally the minimum wait time is thus zero. As such the UE selects a random timer value up to the timer value represented by the ‘Maximum registration wait time’ field.

The skilled person will appreciate that the second option demonstrates how an existing IE can be used to indicate a maximum waiting time (which is to be used with discontinuous coverage or after return from loss of coverage) without needing to consider (or use) a minimum waiting time.

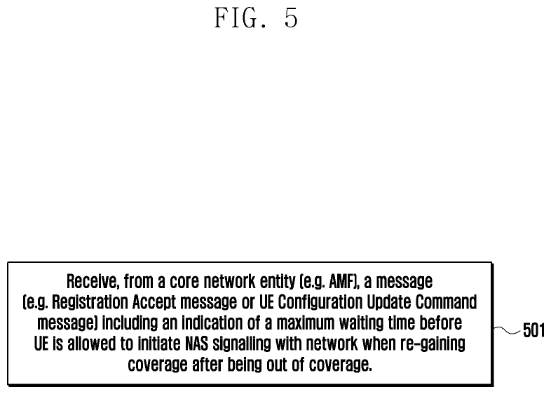

FIG. 5 illustrates a method, for a UE in a network, for controlling re-gaining of coverage after being out of coverage with a network access node according to an embodiment of the disclosure.

In a first operation 501, the UE receives, from a core network entity (e.g. AMF), a message (e.g. Registration Accept message or UE Configuration Update Command message) including an indication of a maximum waiting time before the UE is allowed to initiate NAS signalling with the network when re-gaining coverage after being out of coverage.

The skilled person will appreciate that although the field name refers to registration, the UE does not limit this time to registration procedure only. Hence the fields can refer to timers that would cause the UE to wait before initiating any NAS signalling procedure or before sending any NAS message that is not necessarily a registration procedure (or a Registration Request message).

The skilled person will appreciate that the techniques described herein can apply in any order or combination. In certain examples, the procedures described herein may apply for a UE and/or a network which have negotiated capabilities for discontinuous coverage, and/or in cases in which an IE is sent/received (in a NAS message which is in turn sent/received) over a satellite access.

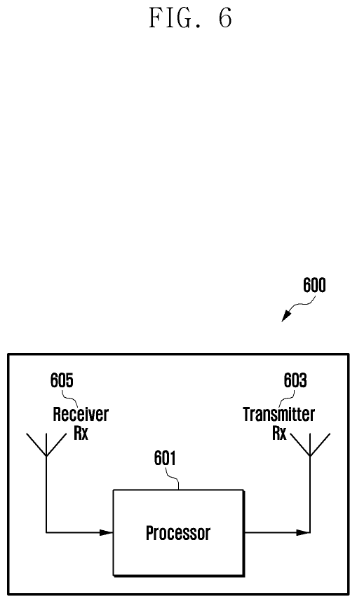

FIG. 6 is a block diagram of a network entity that may be used in examples according to an embodiment of the disclosure.

The skilled person will appreciate that a network entity may be implemented, for example, as a network element on a dedicated hardware, as a software instance running on a dedicated hardware, and/or as a virtualized function instantiated on an appropriate platform, e.g. on a cloud infrastructure.

The entity 600 comprises a processor (or controller) 601, a transmitter 603 and a receiver 605. The receiver 605 is configured for receiving one or more messages from one or more other network entities, for example as described above. The transmitter 603 is configured for transmitting one or more messages to one or more other network entities, for example as described above. The processor 601 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or non-volatile storage, for example a storage device like a read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like.

It will be appreciated that the storage devices and storage media are embodiments of machine-readable storage that are suitable for storing a program or programs comprising instructions that, when executed, implement certain examples of the disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and detail may be made therein without departing from the spirit and scope of the disclosure, as defined by the appended claims and their equivalents.

What is claimed is:

1. A method performed by a terminal in a wireless communication system, the method comprising:
transmitting, to an access and mobility management function (AMF), a message;
identifying whether the terminal has included information on an unavailability and has not included information on a start of an unavailability period in the message; and
in case that the terminal has included the information on the unavailability and has not included the information on the start of the unavailability period in the message, starting a timer associated with releasing a non-access stratum (NAS) signalling connection,
wherein the information on the unavailability comprises at least one of information indicating a reason for the unavailability, information indicating a presence of information on an unavailability period duration, or information indicating a presence of the information on the start of the unavailability period.

2. The method of claim 1, wherein the message comprises a tracking area update request message or a registration request message.

3. The method of claim 1, wherein the information on the unavailability further comprises information on a length of unavailability information contents.

4. The method of claim 1,
wherein, in case that the information indicating the presence of the information on the unavailability period duration indicates that the information on the unavailability period duration is present, the information on the unavailability further comprises the information on the unavailability period duration, and
wherein, in case that the information indicating the presence of the information on the start of the unavailability period indicates that the information on the start of the unavailability period is present, the information on the unavailability further comprises the information on the start of the unavailability period.

5. A method performed by an access and mobility management function (AMF) in a wireless communication system, the method comprising:
receiving, from a terminal, a message,
wherein, in case that the terminal has included information on an unavailability and has not included information on a start of an unavailability period in the message, a timer associated with releasing a non-access stratum (NAS) signalling connection is started, and
wherein the information on the unavailability comprises at least one of information indicating a reason for the unavailability, information indicating a presence of information on an unavailability period duration, or information indicating a presence of the information on the start of the unavailability period.

6. The method of claim 5,
wherein the message comprises a tracking area update request message or a registration request message, and
wherein the information on the unavailability further comprises information on a length of unavailability information contents.

7. The method of claim 5,
wherein, in case that the information indicating the presence of the information on the unavailability period duration indicates that the information on the unavailability period duration is present, the information on the unavailability further comprises the information on the unavailability period duration, and
wherein, in case that the information indicating the presence of the information on the start of the unavailability period indicates that the information on the start of the unavailability period is present, the information on the unavailability further comprises the information on the start of the unavailability period.

8. A terminal in a wireless communication system, the terminal comprising:
a transceiver; and
at least one processor coupled with the transceiver and configured to:
transmit, to an access and mobility management function (AMF), a message,
identify whether the terminal has included information on an unavailability and has not included information on a start of an unavailability period in the message, and
in case that the terminal has included the information on the unavailability and has not included the information on the start of the unavailability period in the message, start a timer associated with releasing a non-access stratum (NAS) signalling connection,
wherein the information on the unavailability comprises at least one of information indicating a reason for the unavailability, information indicating a presence of information on an unavailability period duration, or information indicating a presence of the information on the start of the unavailability period.

9. The terminal of claim 8, wherein the message comprises a tracking area update request message or a registration request message.

10. The terminal of claim 8, wherein the information on the unavailability further comprises information on a length of unavailability information contents.

11. The terminal of claim 8,
wherein, in case that the information indicating the presence of the information on the unavailability period duration indicates that the information on the unavailability period duration is present, the information on the unavailability further comprises the information on the unavailability period duration, and
wherein, in case that the information indicating the presence of the information on the start of the unavailability period indicates that the information on the start of the unavailability period is present, the information on the unavailability further comprises the information on the start of the unavailability period.

12. An access and mobility management function (AMF) in a wireless communication system, the AMF comprising:
a transceiver; and
at least one processor coupled with the transceiver and configured to:
receive, from a terminal, a message,
wherein, in case that the terminal has included information on an unavailability and has not included information on a start of an unavailability period in the message, a timer associated with releasing a non-access stratum (NAS) signalling connection is started, and
wherein the information on the unavailability comprises at least one of information indicating a reason for the unavailability, information indicating a presence of information on an unavailability period duration, or information indicating a presence of the information on the start of the unavailability period.

13. The AMF of claim 12, wherein the message comprises a tracking area update request message or a registration request message.

14. The AMF of claim 12, wherein the information on the unavailability further comprises information on a length of unavailability information contents.

15. The AMF of claim 12,
wherein, in case that the information indicating the presence of the information on the unavailability period duration indicates that the information on the unavailability period duration is present, the information on the unavailability further comprises the information on the unavailability period duration, and
wherein, in case that the information indicating the presence of the information on the start of the unavailability period indicates that the information on the start of the unavailability period is present, the information on the unavailability further comprises the information on the start of the unavailability period.
